(19) United States
(12) Patent Application Publication
(10) Pub. No.: US 2015/0199958 A1
(43) Pub. Date: Jul. 16, 2015

(54) TEXT TO AUDIO CONVERSION OF SOCIAL MEDIA CONTENT

(71) Applicant: Harman International Industries, Incorporated, Stamford, CT (US)

(72) Inventors: David MOORE, New York, NY (US); Milton MELENDEZ, New York, NY (US); Chris CARACCIOLO, New York, NY (US); Michael GOLD, New York, NY (US); Christine HANLON, New York, NY (US); Jane KIM, New York, NY (US); Eduardo SILVA, New York, NY (US); William EVERICH, New York, NY (US)

(21) Appl. No.: 14/595,036

(22) Filed: Jan. 12, 2015

Related U.S. Application Data
(60) Provisional application No. 61/926,646, filed on Jan. 13, 2014.

(51) Int. Cl. G10L 13/08

(52) U.S. Cl. CPC G10L 13/08

(57) ABSTRACT

Systems, methods, and computer program products to perform an operation comprising identifying a predefined trigger in a text published on a social media platform, generating an audio representation of the text, and publishing the audio representation on the social media platform.

### CROSS-REFERENCE TO RELATED APPLICATIONS

This application claims benefit of U.S. provisional patent application Ser. No. 61/926,646, filed Jan. 13, 2014, which is herein incorporated by reference in its entirety.

### BACKGROUND

The present invention relates to computer software, and more specifically, to computer software which generates an audio representation of text published on social media (or networking) platforms.

### SUMMARY

Embodiments disclosed herein include systems, methods, and computer program products to perform an operation comprising identifying a predefined trigger in a text published on a social media platform, generating an audio representation of the text, and publishing the audio representation on the social media platform.

### BRIEF DESCRIPTION OF THE SEVERAL VIEWS OF THE DRAWINGS

FIG. 1 is a block diagram illustrating a system which generates audio representations of the text of social media content, according to one embodiment.

FIG. 2 illustrates techniques to generate audio representations of the text of social media content, according to one embodiment.

FIG. 3 is a flow chart illustrating a method to generate audio representations of the text of social media content, according to one embodiment.

FIG. 4 is a flow chart illustrating a method to create audio representations of social media content.

### DETAILED DESCRIPTION

Embodiments disclosed herein provide techniques to generate music (or any type of audio) based on the text of social media messages (also referred to as publications, posts, or broadcasts) created by users. For example, a user may compose and broadcast a message that reads “res ipsa loquitor” on a social media site. Responsive to receiving the message, embodiments disclosed herein may generate music that is customized based on the text of the user's message. Stated differently, embodiments disclosed herein may generate an audio interpretation of the text of the user's message. Embodiments disclosed herein may then make the customized music available to the users via the social media site.

Stated differently, embodiments disclosed herein convert the letters, characters, and/or numbers in a social media message into corresponding loops of music. When the user creates a message and clicks to publish (or share), embodiments disclosed herein apply a conversion algorithm to create groupings of text (such as 3-character groupings), and convert each character grouping to a custom song (or other audio). After each character grouping in the message is converted to audio, embodiments disclosed herein blend (or mix) each corresponding audio portion into a full song. The full song then gets published on the social media platform, granting access to the user, who can play the custom song via the social media platform.

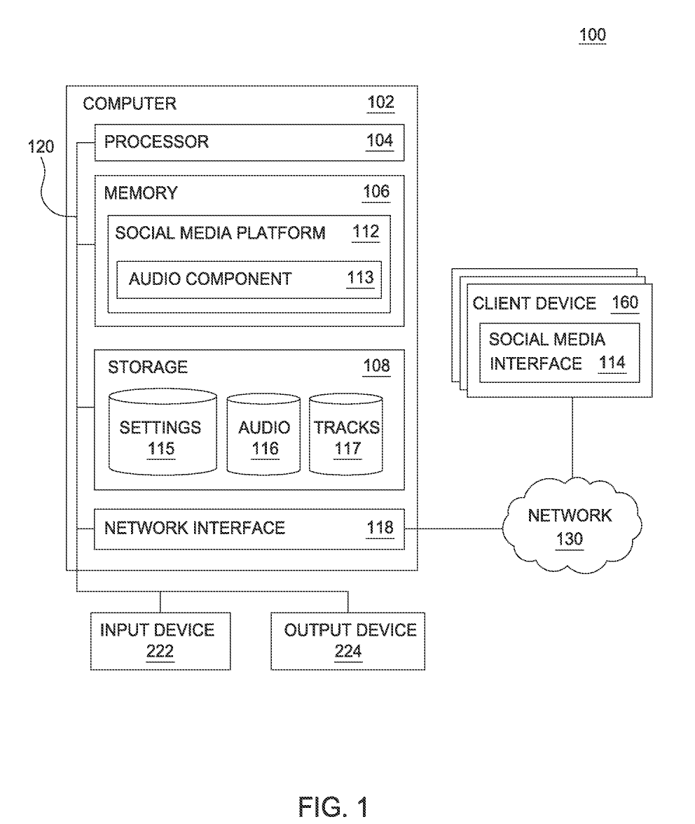

FIG. 1 is a block diagram illustrating a system 100 which generates audio representations of the text of social media content (such as messages, publications, broadcasts, and the like), according to one embodiment. The networked system 100 includes a computer 102. The computer 102 may also be connected to other computers via a network 130. In general, the network 130 may be a telecommunications network and/or a wide area network (WAN). In a particular embodiment, the network 130 is the Internet.

The computer 102 generally includes a processor 104 which obtains instructions and data via a bus 120 from a memory 106 and/or a storage 108. The computer 102 may also include one or more network interface devices 118, input devices 122, and output devices 124 connected to the bus 120. The computer 102 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used. The processor 104 is a programmable logic device that performs instruction, logic, and mathematical processing, and may be representative of one or more CPUs. The network interface device 118 may be any type of network communications device allowing the computer 102 to communicate with other computers via the network 130.

The storage 108 is representative of hard-disk drives, solid state drives, flash memory devices, optical media and the like. Generally, the storage 108 stores application programs and data for use by the computer 102. In addition, the memory 106 and the storage 108 may be considered to include memory physically located elsewhere; for example, on another computer coupled to the computer 102 via the bus 120.

The input device 122 may be any device for providing input to the computer 102. For example, a keyboard and/or a mouse may be used. The input device 122 represents a wide variety of input devices, including keyboards, mice, controllers, and so on. Furthermore, the input device 122 may include a set of buttons, switches or other physical device mechanisms for controlling the computer 102. The output device 124 may include output devices such as monitors, touch screen displays, and so on.

As shown, the memory 106 contains a social media platform 112, which is generally configured to provide a social media platform. Examples of social media platforms include, without limitation, Twitter®, Facebook®, and LinkedIn®. Using the social media platform 112, users may publish any type of content, such as text, links, images, video, and the like. In addition, the social media platform 112 includes an audio component 113, which is configured to convert social media content to a corresponding segment of audio (or music). For example, a user may compose and broadcast a text-based message using a social media interface 114 executing on a client computing device 160. The social media platform 112 may receive the message, and invoke the audio component 113 to convert the text to a respective audio representation. Once the audio component 113 generates the audio representation, the social media platform 112 may publish (or broadcast) the audio representation for the user (and other users).

The audio component 113 may generate audio based the text of social media broadcasts in any feasible manner. In at least one embodiment, the audio component 113 may parse the text of the social media broadcast into three-character segments, although segments of any number of characters may be created. In one embodiment, the audio component 113 may leverage each character in a three-character group to select a specific track (or loop) from the tracks 117 and time the use of the selected track. In one embodiment, the audio component 113 may use the first character in each segment to select a track from the tracks 117. For example, the letter “A” may select an audio loop numbered 1 from the tracks 117, while the letter “a” may select loop numbered 32 from the tracks 117 (the loop numbers may be based on rankings of alphanumeric characters, for example, where capital “A” is the first ranked character). For a given audio loop selected according to the first character, the audio component 113 uses the two remaining characters in the three-character group to select a start point and an end point, thereby defining an audio segment of the selected track. For example, the audio component 113 may use the second character of the three-character segment to select the start point in the selected track. In particular, the position of the 2^{nd} character in the alphabet is used to select a bar with the corresponding position in the loop. For example, if the second character in a three-character segment is an “e,” the fifth letter in the alphabet, the selected track will begin at the fifth bar of the loop. Likewise, the audio component may use the position of the third character in the alphabet to select the end point of the selected track. For example, if the third character in a three-character segment is a “Z,” the audio component may select the 26^{th} bar of the loop as the end point of the loop. The audio component may repeat this process for each group of three characters in the text of the social media message. Therefore, for example, if the word “THE” comprises a three-character grouping from a user's composition, the audio component 113 may select a track numbered 20 for “T,” begin at bar 8 of track 20 for “H,” and end (for the purposes of generating an audio representation of the current social media message) at bar 5 of track 20 for “E.” Although this example uses the first character in a grouping to select the track, the second character to select a start point within the selected track, and the third character to select an end point within the selected track, such an example should not be considered limiting of the disclosure. For example, in another embodiment, the third character may select the track, the second character may be used to select the end point of the selected track, and the first character may be used to select the end point of the selected track.

The audio component 113 may translate each grouping of three characters until a track is selected for each grouping. The audio component 113 may then blend each selected track together, and export a music file (which may be saved in the audio 116). Therefore, for a user's composition that has 30 characters of text, the audio component 113 may create 10 different tracks based on 10 different three-character text segments. The audio component 113 may then merge the 10 tracks to create a final audio track for the user's message. The audio component 113 and/or the social media platform 112 may then store the final audio track in the audio 116, and make the final audio track available via the social media platform 112 (or another website). In at least one embodiment, the social media platform 112 and/or the audio component 113 may create an association between the original text message (or broadcast) and the final audio track. This association can then be used to retrieve the final audio track.

As shown, the storage 108 contains a settings store 115, an audio store 116, and tracks 117. The settings 115 may include keywords, triggers, and other predefined settings that the social media platform 112 and/or the audio component 113 may leverage when creating audio (or music) from a user's text broadcasts. These predefined settings may allow certain artifacts in text broadcasts to be identified and processed differently than the character groupings described above. For example, the phrase “rockandroll” may be defined as a keyword in the settings 115. The settings 115 may specify a particular song, voice, or other segment of audio which the audio component 113 includes in the generated audio representation of the user's text broadcasts when “rockandroll” is included in the user's text. In another embodiment, once an audio track has been generated based on character groupings and/or keywords in the manner described above, one or more acoustical characteristics of the audio track can be modified with custom triggers included with the text broadcast. As an example, “#hashtag” may be defined as a custom trigger in the settings 115 which allows the user to customize the audio generated by the audio component 113 with a specific instrument, music style, and/or tempo. As another example, the settings 115 may specify frequently used keywords or phrases that the audio component 113 may convert into voice audio or special tracks stored in the tracks 117. Generally, any number and type of settings may be stored in the settings 115. The audio store 116 stores audio files generated by the audio component 113. The tracks 117 includes a plurality of predefined audio tracks (or loops) used by the audio component 113 to create audio representations of text published via the social media platform 112. The tracks (or loops) may be numbered according to a predefined numbering sequence, which allows the audio component 113 to translate a character into a track. For example, as previously indicated, the letter “A” may correspond to the first numbered audio track in the tracks 117, while the letter “B” may correspond to the second numbered audio track in the tracks 117, and so on.

As shown, a plurality of client devices 160 execute the social media interface 114. The client devices 160 may be any computing device, such as a computer, smart phone, tablet, and the like. The social media interface 114 may be any interface to the social media platform 112, such as a standalone application, web-based interface accessed via a web browser, and the like. Generally, users (and applications) may use the social media interface 114 to publish (or broadcast) social media messages (such as Tweets, status messages, and the like) via the social media platform 112. When a message is broadcasted via the social media platform 112, other users of the social media platform 112 may view the message. In addition, as described above, other users may access the audio representation of the message generated by the audio component 113.

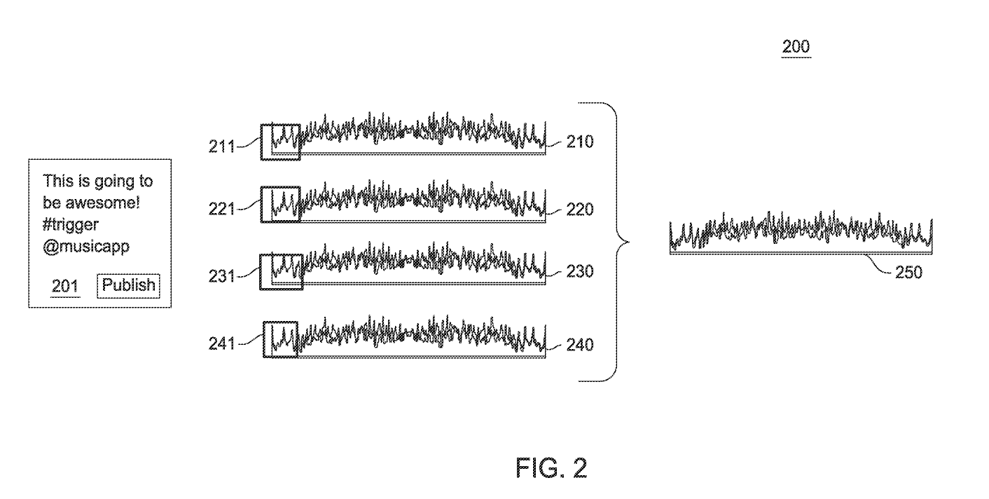

FIG. 2 is a schematic 200 illustrating techniques to generate audio representations of the text of social media content, according to one embodiment. As shown, the schematic 200 includes an example social media message 201. The message 201 may be composed by a user (or a computer program configured to generate and publish social media messages) using the social media interface 114 executing on a client device 160. As shown, the message 201 reads “This is going to be awesome! #trigger @musicapp”. When the user (or program) publishes the message 201, the social media platform 112 executing on the computer 102 may receive and process the message 201. The social media platform 112 may publish the message 201 for other users to view via the social media interface 114. In addition, the social media platform 112 may identify a predefined trigger in the message 201, such as the “#trigger” portion of the message 201, which causes the social media platform 112 to invoke the audio component 113. The trigger may also be the recipient of the message 201, namely the “@musicapp” portion of the text, where the “@” symbol identifies the social media user account “musicapp” as the recipient, or target, of the message 201.

When invoked, the audio component 113 generates a set of audio loops 210, 220, 230, 240, each audio loop corresponding to different text segments of the message 201. In one embodiment, the audio component 113 creates a respective loop for each three-character segment of the message 201. While the message 201 includes more than 12 characters (and therefore more than four three-character segments), only four loops 210, 220, 230, 240 are depicted for the sake of clarity. The loops 210, 220, 230, 240 are individual audio tracks that may overlay each other. The segments 211, 221, 231, and 241 may be a portion of the respective audio track that is selected based on two characters in each three-character grouping. For example, the start point of each segment 211, 221, 231, and 241 may be selected based on the second character in the grouping, while the end point of each segment 211, 221, 231, and 241 may be selected based on the third character in each grouping. As shown, the audio component 113 may then merge each segment 211, 221, 231, and 241 to create a final audio track 250. The audio component 113 and/or the social media platform 112 may store the final audio track 250 in the audio store 116. In some embodiments, the settings 116 may specify frequently used keywords or phrases that the audio component 113 may convert into voice audio or special tracks.

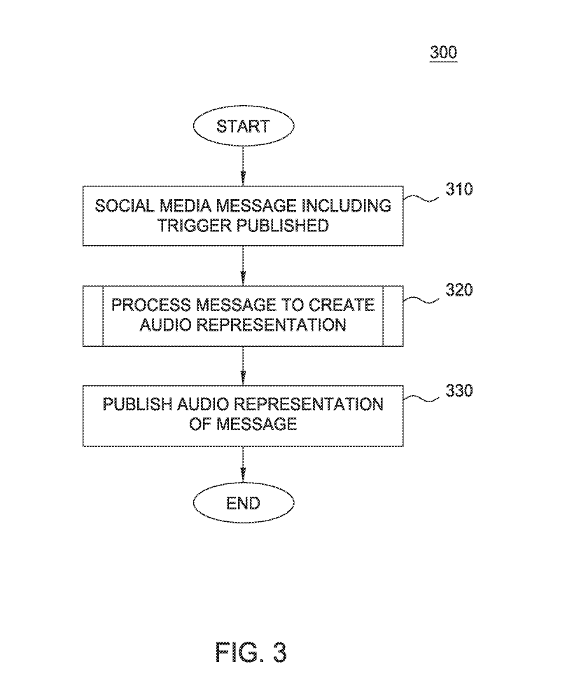

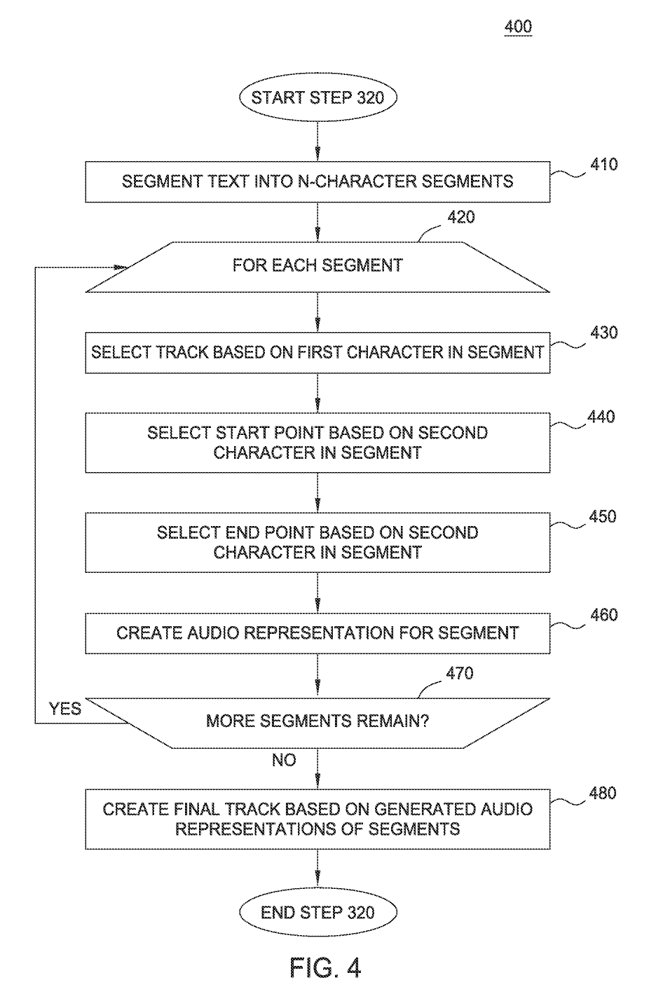

FIG. 3 is a flow chart illustrating a method 300 to generate audio representations of the text of social media content, according to one embodiment. As shown, the method 300 begins at step 310, where a user (or application) publishes a social media message including a predefined trigger. At step 320, described in greater detail with reference to FIG. 4, the social media platform 112 and/or the audio component 113 may process the message published at step 310 to create an audio representation of the message. At step 330, the social media platform 112 and/or the audio component 113 may publish the audio representation of the message generated at step 320.

FIG. 4 is a flow chart illustrating a method 400 corresponding to step 320 to create audio representations of social media content. When a user or program generates a text-based message that is received by the social media platform 112, the social media platform may identify a predefined trigger in the message and invoke the audio component 113 to create an audio track that is customized based on the text of the message.

As shown, the method 400 begins at step 410, where the audio component 113 may segment the text of the message (or broadcast) into N-character segments. In at least one embodiment, the audio component 113 creates segments having three characters, or 3-character segments. In at least one embodiment, as described above, the audio component 113 may identify special keywords or other triggers in the text of the message that cause the audio component 113 to perform an associated operation (such as playing an explosion sound effect when the text “boom” is identified in the text of the message). At step 420, the audio component 113 executes a loop including steps 430-460 for each segment of characters generated at step 410. At step 430, the audio component 113 may select an audio track from the tracks 117 based on the first character in the current three-character segment. For example, if “A” is the first character in the segment, the audio component 113 may select track #1 in the tracks 117, while selecting track #2 in the tracks 117 if “B” is the first character in the segment. At step 440, the audio component 113 may select a start point for the selected track based on the second character in the three-character segment. For example, if “A” is the second character in the segment, the audio component 113 may select the first bar of track #1 as the start point for the generated audio track of the current three-character segment. At step 450, the audio component 113 may select an end point for the selected track based on the third character in the current three-character segment. For example, if “C” is the third character in the segment, the audio component 113 may select the third bar of track #1 as the start point for the generated audio track of the current three-character segment. At step 450, the audio component 113 may create an audio representation for the current segment. The audio representation for the current segment may include the track selected at step 430, which begins at the start point selected at step 440, and ends at the end point selected at step 450. For example, for the three-character grouping “ABC” described above, the audio component 113 may generate an audio representation for the “ABC” grouping by using the second through third bars of audio track #1. In addition, the audio component 113 may include logic to ensure that tracks of a minimum length are produced, and that the start point of a loop precedes the end point of a loop.

At step 470, the audio component 113 determines whether more segments of characters remain. If more segments remain, the audio component 113 returns to step 420. If no more segments remain, the audio component 113 may proceed to step 480. At step 480, the audio component 113 may create a final audio track based on each of the audio representations of the segments generated at each iteration of step 460. For example, the audio component 113 may blend each audio segment generated at step 460 to create a final audio track. In at least one embodiment, the social media platform 112 and/or the audio component 113 may save the final audio track to the audio store 116, and make the final audio track available for user access. In at least one embodiment, the social media platform 112 may publish a link to the audio track via a social media publication, email, text message, and the like. For example, the social media application 112 may publish a link to the audio track in a social media message that is responsive to the user's original social media composition.

Advantageously, embodiments disclosed herein create audio tracks that are customized based on the text of social media messages (or broadcasts, or publications). Embodiments disclosed herein may partition the text into segments of predefined length, and select tracks based on the characters in each segment. The start and end points of the tracks may be based on other characters in each segment. The tracks selected for each segment may then be converted into a single audio track representative of the text in the original message.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the foregoing, reference is made to embodiments presented in this disclosure. However, the scope of the present disclosure is not limited to specific described embodiments. Instead, any combination of the recited features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the recited aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications or related data available in the cloud. For example, the social media platform 112 could execute on a computing system in the cloud and invoke the audio component 113 to generate audio representations of social media broadcasts or publications. In such a case, the social media platform 112 could store the generated audio representations at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method, comprising:
identifying a predefined trigger in a text published on a social media platform;
generating an audio representation of the text; and
publishing the audio representation on the social media platform.

2. The method of claim 1, wherein the predefined trigger comprises one or more of: (i) a predefined keyword, and (ii) a target of the published text.

3. The method of claim 1, wherein the text is published by at least one of: (i) a user, and (ii) an application.

4. The method of claim 1, wherein generating the audio representation of the text comprises:
partitioning the text into a plurality of segments, each of the plurality of segments comprising a predefined number of characters of text; and
generating, for each of the plurality of segments of text, a respective audio loop.

5. The method of claim 4, wherein generating a first audio loop, of the plurality of audio loops comprises:
selecting a first audio track, of a plurality of audio tracks, based on a first character in the respective segment;
selecting a start time for the first audio track based on a second character in the respective segment;
selecting an end time for the first audio track basedon a third character in the respective segment; and
creating the first audio loop, wherein the first audio loop comprises a segment of the first audio track which begins at the selected start time and ends at the selected end time.

6. The method of claim 5, wherein generating the audio representation of the text comprises:
merging the respective audio loops to create a final audio track.

7. The method of claim 6, wherein the first audio track is selected based upon a predefined keyword in the text.

8. A system, comprising:
one or more computer processors; and
a memory containing a program, which when executed by the processors, performs an operation comprising:
identifying a predefined trigger in a text published on a social media platform;
generating an audio representation of the text; and
publishing the audio representation on the social media platform.

9. The system of claim 8, wherein the predefined trigger comprises one or more of: (i) a predefined keyword, and (ii) a target of the published text.

10. The system of claim 8, wherein the text is published by at least one of: (i) a user, and (ii) an application.

11. The system of claim 8, wherein generating the audio representation of the text comprises:
partitioning the text into a plurality of segments, each of the plurality of segments comprising a predefined number of characters of text;
generating, for each of the plurality of segments of text, a respective audio loop; and
merging the respective audio loops to create a final audio track.

12. The system of claim 11, wherein generating a first audio loop, of the plurality of audio loops comprises:
selecting a first audio track, of a plurality of audio tracks, based on a first character in the respective segment;
selecting a start time for the first audio track based on a second character in the respective segment;
selecting an end time for the first audio track basedon a third character in the respective segment; and
creating the first audio loop, wherein the first audio loop comprises a segment of the first audio track which begins at the selected start time and ends at the selected end time.

13. The system of claim 12, wherein generating the audio representation of the text comprises:
merging the respective audio loops to create a final audio track.

14. The system of claim 13, wherein the first audio track is selected based upon a predefined keyword in the text.

15. A computer program product, comprising:
a computer-readable storage medium having computer-readable program code embodied therewith, the computer-readable program code executable by one or more computer processors to:
identify a predefined trigger in a text published on a social media platform;
generate an audio representation of the text; and
publish the audio representation on the social media platform.

16. The computer program product of claim 15, wherein the predefined trigger comprises one or more of: (i) a predefined keyword, and (ii) a target of the published text.

17. The computer program product of claim 15, wherein the text is published by at least one of: (i) a user, and (ii) an application.

18. The computer program product of claim 15, wherein generating the audio representation of the text comprises:
partitioning the text into a plurality of segments, each of the plurality of segments comprising a predefined number of characters of text;
generating, for each of the plurality of segments of text, a respective audio loop; and
merging the respective audio loops to create a final audio track.

19. The computer program product of claim 19, wherein generating a first audio loop, of the plurality of audio loops comprises:
selecting a first audio track, of a plurality of audio tracks, based on a first character in the respective segment;
selecting a start time for the first audio track based on a second character in the respective segment;
selecting an end time for the first audio track based on a third character in the respective segment; and
creating the first audio loop, wherein the first audio loop comprises a segment of the first audio track which begins at the selected start time and ends at the selected end time.

20. The computer program product of claim 19, wherein generating the audio representation of the text comprises:
merging the respective audio loops to create a final audio track.
